(19) United States
(12) Patent Application Publication
(10) Pub. No.: US 2023/0095310 A1
(43) Pub. Date: Mar. 30, 2023

(54) Low-heavy rare earth magnet and manufacturing method thereof

(71) Applicant: Yantai Dongxing Magnetic Materials Inc., Yantai (CN)

(72) Inventors: Chuanshen WANG, Yantai (CN); Zhongjie PENG, Yantai (CN); Kunkun YANG, Yantai (CN); Kaihong DING, Yantai (CN)

(21) Appl. No.: 17/951,136

(22) Filed: Sep. 23, 2022

(30) Foreign Application Priority Data
Sep. 24, 2021 (CN) 202111121038.0

(51) Int. Cl. H01F 41/02; H01F 1/057; B22F 9/04; B22F 3/16; B22F 3/24; C22C 38/16; C22C 38/14; C22C 38/06; C22C 38/10; C22C 38/00

(52) U.S. Cl. CPC H01F 41/0293; H01F 1/0577; H01F 41/0266; B22F 9/04; B22F 3/16; B22F 3/24; C22C 38/16; C22C 38/14; C22C 38/06; C22C 38/10; C22C 38/005; C22C 38/002; B22F 2301/355; B22F 2003/248; C22C 2202/02

(57) ABSTRACT

The disclosure relates to a method of preparing a low-heavy rare earth magnet comprising the following steps:
S1, smelting and strip casting of the raw materials of a NdFeB alloy to obtain a NdFeB alloy sheets, and mechanically crushing the NdFeB alloy sheets into flaky alloy sheets;
S2, mechanically mixing the flaky alloy sheets, a low melting point powder and a lubricant to obtain a mixture, followed by hydrogen absorption and dehydrogenation treatment of the mixture and jet milling of the product to obtain a NdFeB magnet powder;
S3, pressing, forming and sintering the NdFeB magnet powder to obtain a sintered NdFeB magnet;
S4, mechanically processing the sintered NdFeB magnet to a desired shape, and then forming a diffusion source film on the surface of the sintered NdFeB magnet; and
S5, performing a diffusion process and aging to obtain the low-heavy rare earth magnet.

### CROSS-REFERENCE TO RELATED APPLICATIONS

This application is based on Chinese Patent Application No. 202111121038.0, filed on Sep. 24, 2021, which claims the benefit of priority to the Chinese Patent Application, which is incorporated by reference in its entirety herein.

### BACKGROUND

### Field of the Disclosure

The disclosure relates to the technical field of sintered type NdFeB permanent magnets, in particular to a low-heavy rare earth magnet and a corresponding manufacturing method thereof.

### Description of the Prior Art

NdFeB sintered permanent magnets are widely used in high-tech fields such as electronic equipment, medical equipment, electric vehicles, household products, robots, etc. In the past few decades of development, NdFeB permanent magnets have been rapidly developed and the residual magnetic properties have basically reached the theoretical limit. However, the gap between the coercive force and the theoretical value is still very large, so improving the coercive force of the magnet is a major research hotspot.

Heavy rare earths terbium (Tb) or Dysprosium (Dy) are added for greatly improving the magnetic coercivity of the NdFeB magnets. According to one conventional manufacturing process, Tb or Dy are directly mixed into the magnet alloy powders, but consume large amounts of Tb or Dy thereby significantly increasing the material costs. According to an improved manufacturing process, the amount of Tb or Dy can be greatly reduced by applying the grain boundary diffusion technology, but still the material costs are very high for the heavy rare earths. The Nd₂Fe₁₄B main phase is hardened by diffusion containing a heavy rare earth element, forming a large number of core-shell structures. Therefore, it is still important to continuously reduce the total content of heavy rare earths in the NdFeB magnet.

Although increasing the coercivity is most effective through diffusing heavy rare earths, the abundance of heavy rare earths is low and accordingly the price is expensive. Therefore, more and more researchers are preparing heavy rare earth alloys with low melting point to obtain with improved coercivity.

CN106024253A disclosed NdFeB magnets which are diffused with Tb, Dy or Ho, contain an M2 boride phase, an HR enrichment layer and a specific core-shell structure including an (R,HR)—Fe(Co)-M1 phase covering the main phase. In CN108305772A the diffusion source is a hydride powder of an R1-R2-M type alloy, whose melting point is 400 to 800° C. CN111524674A provided a magnet characterized by a grain-bounded epitaxial layer, namely a two-particle boundary phase RₓHo_{y}Cu_{z}X1, is proposed to greatly increase the performance of the magnet after diffusion.

In the above techniques, the magnets are to form a specific phase or use low-cost diffusion sources for reducing the production cost of the magnets. However, there is still a need to further reduce the content of heavy rare earths of NdFeB magnets.

### SUMMARY

The present disclosure provides a low-heavy rare earth magnet (i.e. a sintered NdFeB magnet including a low content of heavy rare earth elements) and a corresponding manufacturing method. A special diffusion source for the diffusion process is coated onto a sintered NdFeB magnet of a well-defined magnet composition, a diffusion process and aging are performed to form a high-performance magnet with a specific phase structure. Even in the presence of low content of heavy rare earth, the magnet shows a greatly increased coercivity. It is assumed that the combination of the specific grain boundary structure and the diffusion source can greatly improve the coercivity.

There is provided a method of preparing a low-heavy rare earth magnet comprising the following steps:

S1, smelting and strip casting of the raw materials of a NdFeB alloy to obtain a NdFeB alloy sheets and mechanically crushing the NdFeB alloy sheets into flaky alloy sheets, where the NdFeB alloy has the following composition in weight percentage: 28%≤R≤30%, 0.8%≤B≤1.2%, 0≤Gd≤5%, 0≤Ho≤5%, and 0≤M≤3%, where R is at least two or more elements of Nd, Pr, Ce, La, Tb, and Dy, M is at least one element of Co, Mg, Ti, Zr, Nb, and Mo, and the rest of the NdFeB alloy is Fe;

S2, mechanically mixing the flaky alloy sheets, a low melting point powder and a lubricant to obtain a mixture, followed by hydrogen absorption and dehydrogenation treatment of the mixture and jet milling of the product to obtain a NdFeB magnet powder, where the low melting point powder contains at least one component selected from NdCu, NdAl and NdGa, and a weight percentage of NdCu is 0% to 3%, a weight percentage of the NdAl is 0% to 3%, and a weight percentage of the NdGa is 0% to 3%, each with respect to the total weight of the flaky alloy sheets and the low melting point powder;

S3, pressing and forming and sintering the NdFeB magnet to obtain a sintered NdFeB magnet;

S4, mechanically processing the sintered NdFeB magnet to a desired shape, and then forming a diffusion source film on the surface of the sintered NdFeB magnet, where the diffusion source film includes a diffusion source of formula RₓH_{y}M_{1-x-y}, where R is at least one of Nd, Pr, Ce, La, Ho, and Gd, H is at least one of Tb and Dy, M is at least one of Al, Cu, Ga, Ti, Co, Mg, Zn, and Sn, x and y are set to be 10%≤x≤50% and 40%≤y≤70% in weight percentage; and

S5, performing a diffusion process and aging to obtain the low-heavy rare earth magnet.

According to one embodiment, in the step S2 a weight content of Cu is 0.1% to 0.5%, a weight content of Al is 0.2% to 0.9%, and a weight content of Ga is 0.01% to 0.4%, each with respect to the total weight of the flaky alloy sheets and the low melting point powder.

According to another embodiment, in the NdFeB alloy of the step S 1, R is at least one element of Nd and Pr, and M is at least one element of Co and Ti. Further, the NdFeB alloy sheets may be mechanically crushed into flake alloy sheets of 150 to 400 μm.

According to another embodiment, in the diffusion source of the step S4, R is at least one of Nd and Pr, H is Dy, and M is at least one of Al, Cu, and Ga.

According to another embodiment, in the step S2, the dehydrogenation temperature is 400 to 600° C.

According to another embodiment, in the step S2, an average particle size D50 of the low melting point powder is 200 nm to 4 μm measured by laser diffraction (LD). Further, an average particle size D50 of the NdFeB magnet powder may be 3 to 5 μm after jet milling measured by laser diffraction (LD). The measurement method may be performed according to ISO 13320-1. According to the IUPAC definition, the equivalent diameter of a non-spherical particle is equal to a diameter of a spherical particle that exhibits identical properties to that of the investigated non-spherical particle.

According to another embodiment, in the step S3, the sintering temperature of the NdFeB magnet is 980 to 1060° C. and the sintering time is 6 to 15 h.

According to another embodiment, in the step S5, the diffusion temperature of NdFeB magnets is 850 to 930° C. and the diffusion time is 6 to 30 h.

According to another embodiment, in the step S5, an aging temperature is 420 to 680° C., an aging time is 3 to 10 h, an aging heating rate is 1 to 5° C./min, and an aging cooling rate is 5 to 20° C./min.

A sintered NdFeB magnet is obtained by the above-mentioned preparation method.

A phase structure of the sintered NdFeB magnet may comprise: a main phase, an R shell, a transition metal shell, and a triangular region. The R shell consisting of at least one of Nd, Pr, Ce, La, Ho, and Gd and partially covering the main phase; the transition metal shell consisting of at least one of Cu, Al, and Ga and partially covering the main phase; and the triangular region consisting of at least one composition of Formulas 1 to 3:

Formula 1, NdₐFe_{b}R_{c}M_{d}, where R is at least one element of Pr, Ce, La, Ho, and Gd; M is at least three elements of Al, Cu, Ga, Ti, Co, Mg, Zn, and Sn; and a, b, c, and d are set to be 30%≤a≤70%, 5%≤b≤40%, 5%≤c≤35%, and 0%≤d≤15% in weight percentage;

Formula 2, NdₑFe_{f}R_{g}HₕKᵢMⱼ , where R is at least one element of Pr, Ce, La; H is at least one element of Dy and Tb; M is at least three elements of Al, Cu, Ga, Ti, Co, Mg, Zn, and Sn; and where e, f, g, h, I, and j are set to be 25%≤e≤65%, 5%≤f≤35%, 5%≤g≤30%, 5%≤h≤30%, 5%≤i≤10%, and 0%≤j≤10% in weight percentage;

Formula 3, NdₖFeₗRₘDₙMₒ, where R is at least one element of Pr, Ce, La, Ho, and Gd; D is at least one element of Al, Cu, and Ga; M is at least one element of Ti, Co, Mg, Zn, and Sn; and k, l, m, n, and o are set to be 30 [symbol] ≤70%, 5%≤l≤35%, 5%≤m≤35%, 5%≤n≤25%, and 0%≤o≤10% in weight percentage. The diffusion source may be uniformly distributed in the RH phase and RHM phase.

According to one embodiment, a thickness of the sintered NdFeB magnet may be 0.3 to 6 mm.

Preferably, a low-heavy rare earth diffusion source is atomized milling, amorphous alloy sheets or ingot casting.

The beneficial effects of using the above further scheme are:

1. A grain boundary magnet with low melting point is designed and a special diffusion source with special phase structure are coated with the magnet. A low-heavy rare earth NdFeB magnet with specific grain boundary structure is obtained by diffusion and aging treatment; it's coercivity is greatly improved through the synergy of magnet composition and diffusion source.

2. The diffusion magnet matrix, which contains NdCu, NdAl and NdGa of the low melting point phase, is conducive to increasing the diffusion coefficient of the magnet grain boundary, thereby improving the diffusion efficiency of the diffusion source;

3. The crystal phase structure distribution of the diffusion source is a RM phase and a RHM phase mosaic distribution, which can improve the diffusion coefficient, therefore it is beneficial to enter the magnet for the element of the diffusion source. This way can well form a magnetic isolation effect in the low-heavy rare earth NdFeB magnet, and realize the role of improving the coercivity.

4. The low-heavy rare earth magnet has a characteristic phase, and the mass content of the characteristic phase Fe is <30%, which has non-ferromagnetic properties and can have a good magnetic isolation effect;

5. The present disclosure can reduce the heavy rare earth content in the magnet very well, and greatly reduce the cost of the magnet; The process is simple, which can achieve mass production.

### BRIEF DESCRIPTION OF THE DRAWINGS

FIG. 1 shows a SEM image using ZISS electron microscopy of the microstructure of an exemplary Nd—Fe—B permanent magnet after diffusion and aging.

### DETAILED DESCRIPTION OF THE EMBODIMENTS

Reference will now be made in detail to embodiments. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

### EXEMPLARY EMBODIMENTS

The preparation process of exemplary sintered NdFeB magnets will now be described in detail.

NdFeB alloy raw materials are mixed with different ratios of NdCu, NdAl, and NdGa and a conventional lubricant is added. Magnet compositions No. 1 to 22 are summarized in Table 1 below.

The preparation method of the low-heavy rare earth magnet was as follows:

(1) The raw materials of a NdFeB alloy are smelted and strip casted process to obtain a NdFeB alloy sheets, and the obtained NdFeB alloy sheets are mechanically crushed into flaky alloy sheets of 150 to 400 μm size;

(2) NdCu, NdAl and NdGa as low melting point powders with a particle size range of 200 nm to 4 μm are mixed and added to the flaky alloy sheets;

(3) The mixed materials of the flaky alloy sheets, a low melting point powders and lubricant are put into the hydrogen treatment furnace for hydrogen absorption and dehydrogenation treatment, where the dehydrogenation temperature is 400 to 600° C.; the low melting point alloy powders are coating the flaky alloy sheets; NdFeB powders are prepared by air milling and the NdFeB powder particle size is 3 to 5 μm;

The addition of a lubricant during the jet milling step is well-known; Any common type of lubricant and its dosage can be used; There is no specific restriction;

(4) The NdFeB magnet powders after the air flow grinding is oriented molding and pressed into the blank by isostatic pressure;

(5) The pressing blank of NdFeB is sintered in vacuum, and quickly cooled by argon, and then the blank is heat-treated including a primary tempering and secondary aging. The sintered magnet performance is tested, and the specific process conditions and magnet characteristic are shown in Table 2;

(6) The sintered NdFeB magnet is mechanically processed to obtain the desired shape and then a diffusion source film is coated on the sintered NdFeB magnet; The weight of Dy on the sintered NdFeB magnet is 1.0 wt. %, and the weight of Dy in Dy alloy on the sintered NdFeB magnet is 1.0 wt. %.

An increase in coercivity after diffusion of the Dy alloy reaches 636.8 to 756.2 kA/m, and the process allows reducing the production cost of the magnet due to the low Dy content.

The diffusion sources based on Dy alloys and magnet characteristics of the sintered NdFeB magnets are shown in Table 3.

Pure diffusion examples of Dy and magnet characteristics of the sintered NdFeB magnets are shown in Table 4.

TABLE 1

| | Magnet composition (%) | | | | | | | | | | |
|---|---|---|---|---|---|---|---|---|---|---|---|
| Number | Al | B | Co | Cu | Fe | Ga | Nd | Pr | Ti | Ho | TRE |
| 1 | 0.30 | 0.97 | 1.00 | 0.15 | Margin | 0.05 | 29.52 | | | | 29.52 |
| 2 | 0.59 | 0.95 | 1.00 | 0.15 | Margin | 0.11 | 31.23 | | | | 31.23 |
| 3 | 0.87 | 0.93 | 1.00 | 0.14 | Margin | 0.21 | 33.19 | | | | 33.19 |
| 4 | 0.83 | 0.95 | 1.00 | 0.29 | Margin | 0.05 | 31.51 | | | | 31.51 |
| 5 | 0.41 | 0.92 | 1.00 | 0.29 | Margin | 0.10 | 26.35 | 6.59 | 0.05 | | 32.94 |
| 6 | 0.53 | 0.95 | 1.00 | 0.29 | Margin | 0.21 | 24.81 | 6.20 | 0.05 | | 31.02 |
| 7 | 0.82 | 0.94 | 1.00 | 0.44 | Margin | 0.05 | 25.61 | 6.40 | 0.05 | | 32.02 |
| 8 | 0.53 | 0.95 | 1.00 | 0.44 | Margin | 0.11 | 24.74 | 6.19 | 0.06 | | 30.93 |
| 9 | 0.35 | 0.92 | 1.00 | 0.43 | Margin | 0.21 | 26.19 | 6.55 | 0.05 | | 32.73 |
| 10 | 0.42 | 0.97 | 1.00 | 0.15 | Margin | 0.11 | 23.89 | 5.97 | 0.10 | | 29.86 |
| 11 | 0.59 | 0.94 | 1.00 | 0.15 | Margin | 0.21 | 31.82 | | 0.10 | | 31.82 |
| 12 | 0.86 | 0.92 | 1.00 | 0.14 | Margin | 0.31 | 33.76 | | 0.10 | | 33.76 |
| 13 | 0.82 | 0.94 | 1.00 | 0.29 | Margin | 0.11 | 23.86 | 7.95 | 0.10 | | 31.81 |
| 14 | 0.41 | 0.91 | 1.00 | 0.29 | Margin | 0.21 | 25.14 | 8.38 | 0.10 | | 33.52 |
| 15 | 0.53 | 0.94 | 1.00 | 0.29 | Margin | 0.32 | 23.71 | 7.90 | 0.20 | | 31.61 |
| 16 | 0.81 | 0.94 | 1.00 | 0.43 | Margin | 0.11 | 32.31 | | 0.20 | | 32.31 |
| 17 | 0.53 | 0.94 | 1.00 | 0.44 | Margin | 0.21 | 31.52 | | 0.20 | | 31.52 |
| 18 | 0.35 | 0.91 | 1.00 | 0.43 | Margin | 0.31 | 33.31 | | 0.20 | | 33.31 |
| 19 | 0.31 | 0.97 | 0.91 | 0.20 | Margin | 0.18 | 24.83 | 6.39 | 0.20 | | 31.22 |
| 20 | 0.70 | 1.00 | 1.00 | 0.15 | Margin | 0.20 | 25.00 | 6.20 | 0.10 | | 31.20 |
| 21 | 0.34 | 0.91 | 1.00 | 0.15 | Margin | 0.20 | 22.00 | 5.50 | 0.15 | 3.37 | 30.87 |
| 22 | 0.28 | 0.87 | 0.80 | 0.38 | Margin | 0.37 | 23.62 | 7.60 | 0.10 | | 31.22 |

TABLE 2

| | | | | | | | | | Performance | | |
|---|---|---|---|---|---|---|---|---|---|---|---|
| | Sintering | holding | One-level | holding | Secondary | holding | Heating | Cooling | | Hcj | Hk/ |
| Number | ° C. | h | ° C. | h | ° C. | h | ° C./min | ° C./min | Br(T) | (kA/m) | Hcj |
| 1 | 980 | 15 | 850 | 3 | 450 | 3 | 5 | 5 | 14.55 | 14.29 | 0.99 |
| 2 | 980 | 15 | 850 | 3 | 450 | 3 | 5 | 5 | 13.86 | 16.72 | 0.99 |
| 3 | 980 | 15 | 850 | 3 | 450 | 3 | 5 | 10 | 13.17 | 19.42 | 0.97 |
| 4 | 980 | 15 | 850 | 3 | 450 | 3 | 5 | 15 | 13.56 | 17.48 | 0.98 |
| 5 | 980 | 15 | 850 | 3 | 480 | 3 | 3 | 15 | 13.67 | 16.49 | 0.98 |
| 6 | 1020 | 13 | 850 | 3 | 480 | 3 | 1 | 5 | 13.93 | 16.69 | 0.98 |
| 7 | 1020 | 13 | 850 | 3 | 480 | 3 | 1 | 20 | 13.47 | 17.68 | 0.97 |
| 8 | 1020 | 13 | 850 | 3 | 480 | 3 | 3 | 20 | 13.96 | 16.15 | 0.97 |
| 9 | 1020 | 13 | 850 | 3 | 510 | 3 | 3 | 20 | 13.74 | 16.65 | 0.98 |
| 10 | 1020 | 13 | 850 | 3 | 510 | 3 | 3 | 10 | 14.32 | 15.12 | 0.98 |
| 11 | 1040 | 9 | 850 | 3 | 510 | 3 | 1 | 10 | 13.71 | 17.26 | 0.97 |
| 12 | 1040 | 9 | 850 | 3 | 510 | 3 | 1 | 10 | 13.02 | 19.90 | 0.98 |
| 13 | 1040 | 9 | 850 | 3 | 550 | 3 | 5 | 10 | 13.45 | 18.90 | 0.98 |
| 14 | 1040 | 9 | 850 | 3 | 550 | 3 | 5 | 15 | 13.52 | 17.25 | 0.98 |
| 15 | 1040 | 9 | 850 | 3 | 550 | 3 | 5 | 15 | 13.77 | 17.52 | 0.98 |
| 16 | 1060 | 6 | 850 | 3 | 550 | 3 | 3 | 20 | 13.38 | 18.06 | 0.97 |
| 17 | 1060 | 6 | 850 | 3 | 580 | 3 | 1 | 20 | 13.80 | 16.93 | 0.97 |
| 18 | 1060 | 6 | 850 | 3 | 580 | 3 | 3 | 20 | 13.58 | 17.40 | 0.98 |
| 19 | 1060 | 6 | 850 | 3 | 580 | 3 | 3 | 5 | 13.70 | 18.50 | 0.98 |
| 20 | 1060 | 6 | 850 | 3 | 660 | 3 | 1 | 5 | 13.40 | 19.00 | 0.98 |
| 21 | 1050 | 12 | 850 | 3 | 660 | 3 | 1 | 5 | 13.30 | 18.00 | 0.99 |
| 22 | 1060 | 7 | 850 | 3 | 660 | 3 | 1 | 15 | 13.60 | 20.00 | 0.99 |

TABLE 3

| | | | | | | | | | Performance | | |
|---|---|---|---|---|---|---|---|---|---|---|---|
| | | | Diffusion | holding | Aging | holding | Heating | Cooling | after Diffusion | | |
| | Diffusion | | Temp. | time | Temp. | time | rate | rate | | Hcj | Hk/ |
| Example | Source | Size(mm) | ° C. | hours | ° C. | hours | ° C./min | ° C./min | Br(T) | (kA/m) | Hcj |
| 1 | PrDyCu | 10*10*3 | 850 | 30 | 420 | 10 | 5 | 5 | 1.435 | 1950.2 | 0.97 |
| 2 | PrDyCu | 10*10*3 | 850 | 30 | 480 | 7 | 5 | 5 | 1.362 | 2029.8 | 0.97 |
| 3 | PrDyCu | 10*10*3 | 850 | 30 | 500 | 5 | 5 | 10 | 1.295 | 2149.2 | 0.96 |
| 4 | PrDyCu | 10*10*3 | 880 | 20 | 450 | 8 | 5 | 15 | 1.332 | 1990 | 0.96 |
| 5 | NdDyCu | 10*10*4 | 880 | 20 | 500 | 6 | 3 | 15 | 1.342 | 2069.6 | 0.96 |
| 6 | NdDyCu | 10*10*4 | 880 | 20 | 600 | 5 | 1 | 5 | 1.37 | 1990 | 0.97 |
| 7 | NdDyCu | 10*10*4 | 880 | 20 | 500 | 3 | 1 | 20 | 1.325 | 2109.4 | 0.96 |
| 8 | PrDyCu | 10*10*4 | 900 | 15 | 450 | 8 | 3 | 20 | 1.375 | 2029.8 | 0.96 |
| 9 | PrDyCu | 10*10*5 | 900 | 16 | 500 | 6 | 3 | 20 | 1.35 | 2069.6 | 0.97 |
| 10 | PrDyCu | 10*10*5 | 900 | 17 | 520 | 4 | 3 | 10 | 1.41 | 1990 | 0.97 |
| 11 | PrDyCu | 10*10*5 | 900 | 18 | 600 | 5 | 1 | 10 | 1.35 | 1990 | 0.97 |
| 12 | PrDyCu | 10*10*5 | 900 | 19 | 500 | 3 | 1 | 10 | 1.28 | 2189 | 0.97 |
| 13 | PrDyCuGa | 10*10*3 | 910 | 10 | 450 | 8 | 5 | 10 | 1.32 | 2109.4 | 0.96 |
| 14 | PrDyCuGa | 10*10*3 | 910 | 10 | 500 | 6 | 5 | 15 | 1.33 | 2029.8 | 0.97 |
| 15 | PrDyCuGa | 10*10*3 | 910 | 10 | 520 | 4 | 5 | 15 | 1.352 | 2109.4 | 0.97 |
| 16 | PrDyCuAl | 10*10*3 | 910 | 10 | 450 | 5 | 3 | 20 | 1.315 | 2149.2 | 0.97 |
| 17 | PrDyCuAl | 10*10*3 | 910 | 10 | 480 | 3 | 1 | 20 | 1.36 | 1990 | 0.96 |
| 18 | PrDyCuAl | 10*10*3 | 930 | 6 | 450 | 8 | 3 | 20 | 1.332 | 2069.6 | 0.98 |
| 19 | PrDyCu | 10*10*4 | 930 | 6 | 500 | 6 | 3 | 5 | 1.345 | 2149.2 | 0.97 |
| 20 | PrDyCu | 10*10*4 | 930 | 6 | 520 | 4 | 3 | 5 | 1.32 | 2109.4 | 0.97 |
| 21 | PrDyCu | 10*10*4 | 930 | 6 | 600 | 5 | 1 | 5 | 1.305 | 2189 | 0.98 |
| 22 | PrDyCu | 10*10*4 | 930 | 6 | 680 | 3 | 1 | 15 | 1.34 | 2189 | 0.98 |

TABLE 4

| | | | | | | | | | Performance | | |
|---|---|---|---|---|---|---|---|---|---|---|---|
| | | | Diffusion | holding | Aging | holding | Heating | Cooling | after Diffusion | | |
| | Diffusion | Size | Temp. | time | Temp. | time | rate | rate | | Hcj | Hk/ |
| proportionality | Source | (mm) | ° C. | hours | ° C. | hours | ° C./min | ° C./min | Br(T) | (kA/m) | Hcj |
| 1 | Dy | 10*10*3 | 850 | 30 | 420 | 10 | 5 | 5 | 1.436 | 1791.0 | 0.97 |
| 2 | Dy | 10*10*3 | 850 | 30 | 480 | 7 | 5 | 5 | 1.363 | 1870.6 | 0.97 |
| 3 | Dy | 10*10*3 | 850 | 30 | 500 | 5 | 5 | 10 | 1.297 | 1950.2 | 0.96 |
| 4 | Dy | 10*10*3 | 880 | 20 | 450 | 8 | 5 | 15 | 1.333 | 1791.0 | 0.96 |
| 5 | Dy | 10*10*4 | 880 | 20 | 500 | 6 | 3 | 15 | 1.344 | 1910.4 | 0.96 |
| 6 | Dy | 10*10*4 | 880 | 20 | 600 | 5 | 1 | 5 | 1.372 | 1870.6 | 0.97 |
| 7 | Dy | 10*10*4 | 880 | 20 | 500 | 3 | 1 | 20 | 1.326 | 1990.0 | 0.96 |
| 8 | Dy | 10*10*4 | 900 | 15 | 450 | 8 | 3 | 20 | 1.377 | 1910.4 | 0.96 |
| 9 | Dy | 10*10*5 | 900 | 16 | 500 | 6 | 3 | 20 | 1.352 | 1910.4 | 0.97 |
| 10 | Dy | 10*10*5 | 900 | 17 | 520 | 4 | 3 | 10 | 1.411 | 1830.8 | 0.97 |
| 11 | Dy | 10*10*5 | 900 | 18 | 600 | 5 | 1 | 10 | 1.351 | 1751.2 | 0.97 |
| 12 | Dy | 10*10*5 | 900 | 19 | 500 | 3 | 1 | 10 | 1.282 | 1990.0 | 0.97 |
| 13 | Dy | 10*10*3 | 910 | 10 | 450 | 8 | 5 | 10 | 1.322 | 1950.2 | 0.96 |
| 14 | Dy | 10*10*3 | 910 | 10 | 500 | 6 | 5 | 15 | 1.331 | 1910.4 | 0.97 |
| 15 | Dy | 10*10*3 | 910 | 10 | 520 | 4 | 5 | 15 | 1.354 | 1990.0 | 0.97 |
| 16 | Dy | 10*10*3 | 910 | 10 | 450 | 5 | 3 | 20 | 1.316 | 2029.8 | 0.96 |
| 17 | Dy | 10*10*3 | 910 | 10 | 480 | 3 | 1 | 20 | 1.360 | 1870.6 | 0.98 |
| 18 | Dy | 10*10*3 | 930 | 6 | 450 | 8 | 3 | 20 | 1.333 | 1950.2 | 0.97 |
| 19 | Dy | 10*10*4 | 930 | 6 | 500 | 6 | 3 | 5 | 1.346 | 1950.2 | 0.97 |
| 20 | Dy | 10*10*4 | 930 | 6 | 520 | 4 | 3 | 5 | 1.320 | 1990.0 | 0.98 |
| 21 | Dy | 10*10*4 | 930 | 6 | 600 | 5 | 1 | 5 | 1.306 | 1990.0 | 0.98 |
| 22 | Dy | 10*10*4 | 930 | 6 | 680 | 3 | 1 | 15 | 1.340 | 1990.0 | 0.98 |

Based on the above data, the NdCu, NdAl, NdGa phase powders are added to the grain boundary of the NdFeB alloy flakes, whose grain boundary has a low melting point. The grain boundary channel of NdFeB permanent magnets are suitable for the diffusion, especially when the diffusion source is a heavy rare earth alloys. The coercivity increases significantly to ΔHcj>597 kA/m after diffusion and the coercivity is significantly better than in case of diffusion of pure Dy.

Specifically, the various embodiments of Table 3 and the comparative examples of Table 4 are analyzed as follows:

Example 1, with the same NdFeB magnet composition and size, the same diffusion temperature and aging temperature, etc., the performance of example 1 by diffusion PrDyCu decreased by 0.02 T of Br, increased by 812 kA/m of Hcj compared with the pre-diffusion performance of NdFeB magnet. The performance of comparative example 1 by diffusion Dy decreased by 0.019 T of Br, increased by 653.5 kA/m of Hcj compared with the pre-diffusion performance of NdFeB magnet. Therefore, the Hcj of diffusion PrDyCu increased more significantly and the advantages were more pronounced.

Example 2, with the same NdFeB magnet composition and size, the same diffusion temperature and aging temperature, etc., the performance of example 2 by diffusion PrDyCu decreased by 0.024 T of Br, increased by 699 kA/m of Hcj compared with the pre-diffusion performance of NdFeB magnet. The performance of comparative example 2 by diffusion Dy decreased by 0.023 T of Br, increased by 539.7 kA/m of Hcj compared with the pre-diffusion performance of NdFeB magnet. Therefore, the Hcj of diffusion PrDyCu increased more significantly and the advantages were more pronounced.

Example 3, with the same NdFeB magnet composition and size, the same diffusion temperature and aging temperature, etc., the performance of example 3 by diffusion PrDyCu decreased by 0.022 T of Br, increased by 603.4 kA/m of Hcj compared with the pre-diffusion performance of NdFeB magnet. The performance of comparative example 3 by diffusion Dy decreased by 0.020 T of Br, increased by 404.4 kA/m of Hcj compared with the pre-diffusion performance of NdFeB magnet. Therefore, the Hcj of diffusion PrDyCu increased more significantly and the advantages were more pronounced.

Example 4, with the same NdFeB magnet composition and size, the same diffusion temperature and aging temperature, etc., the performance of example 4 by diffusion PrDyCu decreased by 0.024 T of Br, increased by 598.6 kA/m of Hcj compared with the pre-diffusion performance of NdFeB magnet. The performance of comparative example 4 by diffusion Dy decreased by 0.023 T of Br, increased by 400 kA/m of Hcj compared with the pre-diffusion performance of NdFeB magnet. Therefore, the Hcj of diffusion PrDyCu increased more significantly and the advantages were more pronounced.

Example 5, with the same NdFeB magnet composition and size, the same diffusion temperature and aging temperature, etc., the performance of example 5 by diffusion NdDyCu decreased by 0.025 T of Br, increased by 757 kA/m of Hcj compared with the pre-diffusion performance of NdFeB magnet. The performance of comparative example 5 by diffusion Dy decreased by 0.023 T of Br, increased by 597.8 kA/m of Hcj compared with the pre-diffusion performance of NdFeB magnet. Therefore, the Hcj of diffusion NdDyCu increased more significantly and the advantages were more pronounced.

Example 6, with the same NdFeB magnet composition and size, the same diffusion temperature and aging temperature, etc., the performance of example 6 by diffusion NdDyCu decreased by 0.023 T of Br, increased by 661.5 kA/m of Hcj compared with the pre-diffusion performance of NdFeB magnet. The performance of comparative example 6 by diffusion Dy decreased by 0.021 T of Br, increased by 542 kA/m of Hcj compared with the pre-diffusion performance of NdFeB magnet. Therefore, the Hcj of diffusion NdDyCu increased more significantly and the advantages were more pronounced.

Example 7, with the same NdFeB magnet composition and size, the same diffusion temperature and aging temperature, etc., the performance of example 7 by diffusion NdDyCu decreased by 0.022 T of Br, increased by 702.1 kA/m of Hcj compared with the pre-diffusion performance of NdFeB magnet. The performance of comparative example 7 by diffusion Dy decreased by 0.021 T of Br, increased by 582.7 kA/m of Hcj compared with the pre-diffusion performance of NdFeB magnet. Therefore, the Hcj of diffusion NdDyCu increased more significantly and the advantages were more pronounced.

Example 8, with the same NdFeB magnet composition and size, the same diffusion temperature and aging temperature, etc., the performance of example 8 by diffusion PrDyCu decreased by 0.021 T of Br, increased by 744.3 kA/m of Hcj compared with the pre-diffusion performance of NdFeB magnet. The performance of comparative example 8 by diffusion Dy decreased by 0.019 T of Br, increased by 642.8 kA/m of Hcj compared with the pre-diffusion performance of NdFeB magnet. Therefore, the Hcj of diffusion PrDyCu increased more significantly and the advantages were more pronounced.

Example 9, with the same NdFeB magnet composition and size, the same diffusion temperature and aging temperature, etc., the performance of example 9 by diffusion PrDyCu decreased by 0.024 T of Br, increased by 744.3 kA/m of Hcj compared with the pre-diffusion performance of NdFeB magnet. The performance of comparative example 9 by diffusion Dy decreased by 0.022 T of Br, increased by 585.1 kA/m of Hcj compared with the pre-diffusion performance of NdFeB magnet. Therefore, the Hcj of diffusion PrDyCu increased more significantly and the advantages were more pronounced.

Example 10, with the same NdFeB magnet composition and size, the same diffusion temperature and aging temperature, etc., the performance of example 10 by diffusion PrDyCu decreased by 0.022 T of Br, increased by 786.4 kA/m of Hcj compared with the pre-diffusion performance of NdFeB magnet. The performance of comparative example 10 by diffusion Dy decreased by 0.021 T of Br, increased by 627.2 kA/m of Hcj compared with the pre-diffusion performance of NdFeB magnet. Therefore, the Hcj of diffusion PrDyCu increased more significantly and the advantages were more pronounced.

Example 11, with the same NdFeB magnet composition and size, the same diffusion temperature and aging temperature, etc., the performance of example 11 by diffusion PrDyCu decreased by 0.021 T of Br, increased by 616.1 kA/m of Hcj compared with the pre-diffusion performance of NdFeB magnet. The performance of comparative example 11 by diffusion Dy decreased by 0.02 T of Br, increased by 377.3 kA/m of Hcj compared with the pre-diffusion performance of NdFeB magnet. Therefore, the Hcj of diffusion PrDyCu increased more significantly and the advantages were more pronounced.

Example 12, with the same NdFeB magnet composition and size, the same diffusion temperature and aging temperature, etc., the performance of example 12 by diffusion PrDyCu decreased by 0.022 T of Br, increased by 605 kA/m of Hcj compared with the pre-diffusion performance of NdFeB magnet. The performance of comparative example 12 by diffusion Dy decreased by 0.02 T of Br, increased by 406 kA/m of Hcj compared with the pre-diffusion performance of NdFeB magnet. Therefore, the Hcj of diffusion PrDyCu increased more significantly and the advantages were more pronounced.

Example 13, with the same NdFeB magnet composition and size, the same diffusion temperature and aging temperature, etc., the performance of example 13 by diffusion PrDyCuGa decreased by 0.025 T of Br, increased by 605 kA/m of Hcj compared with the pre-diffusion performance of NdFeB magnet. The performance of comparative example 13 by diffusion Dy decreased by 0.023 T of Br, increased by 445.8 kA/m of Hcj compared with the pre-diffusion performance of NdFeB magnet. Therefore, the Hcj of diffusion PrDyCuGa increased more significantly and the advantages were more pronounced.

Example 14, with the same NdFeB magnet composition and size, the same diffusion temperature and aging temperature, etc., the performance of example 14 by diffusion PrDyCuGa decreased by 0.022 T of Br, increased by 656.7 kA/m of Hcj compared with the pre-diffusion performance of NdFeB magnet. The performance of comparative example 14 by diffusion Dy decreased by 0.021 T of Br, increased by 537.3 kA/m of Hcj compared with the pre-diffusion performance of NdFeB magnet. Therefore, the Hcj of diffusion PrDyCuGa increased more significantly and the advantages were more pronounced.

Example 15, with the same NdFeB magnet composition and size, the same diffusion temperature and aging temperature, etc., the performance of example 15 by diffusion PrDyCuGa decreased by 0.025 T of Br, increased by 714.8 kA/m e of Hcj compared with the pre-diffusion performance of NdFeB magnet. The performance of comparative example 15 by diffusion Dy decreased by 0.023 T of Br, increased by 595.4 kA/m of Hcj compared with the pre-diffusion performance of NdFeB magnet. Therefore, the Hcj of diffusion PrDyCuGa increased more significantly and the advantages were more pronounced.

Example 16, with the same NdFeB magnet composition and size, the same diffusion temperature and aging temperature, etc., the performance of example 16 by diffusion PrDyCuAl decreased by 0.023 T of Br, increased by 711.6 kA/m of Hcj compared with the pre-diffusion performance of NdFeB magnet. The performance of comparative example 16 by diffusion Dy decreased by 0.022 T of Br, increased by 592.2 kA/m of Hcj compared with the pre-diffusion performance of NdFeB magnet. Therefore, the Hcj of diffusion PrDyCuAl increased more significantly and the advantages were more pronounced.

Example 17, with the same NdFeB magnet composition and size, the same diffusion temperature and aging temperature, etc., the performance of example 17 by diffusion PrDyCuAl decreased by 0.02 T of Br, increased by 642.4 kA/m of Hcj compared with the pre-diffusion performance of NdFeB magnet. The performance of comparative example 17 by diffusion Dy decreased by 0.02 T of Br, increased by 523 kA/m of Hcj compared with the pre-diffusion performance of NdFeB magnet. Therefore, the Hcj of diffusion PrDyCuAl increased more significantly and the advantages were more pronounced.

Example 18, with the same NdFeB magnet composition and size, the same diffusion temperature and aging temperature, etc., the performance of example 17 by diffusion PrDyCuAl decreased by 0.026 T of Br, increased by 684.6 kA/m of Hcj compared with the pre-diffusion performance of NdFeB magnet. The performance of comparative example 18 by diffusion Dy decreased by 0.025 T of Br, increased by 565.2 kA/m of Hcj compared with the pre-diffusion performance of NdFeB magnet. Therefore, the Hcj of diffusion PrDyCuAl increased more significantly and the advantages were more pronounced.

Example 19, with the same NdFeB magnet composition and size, the same diffusion temperature and aging temperature, etc., the performance of example 19 by diffusion PrDyCu decreased by 0.025 T of Br, increased by 676.6 kA/m of Hcj compared with the pre-diffusion performance of NdFeB magnet. The performance of comparative example 19 by diffusion Dy decreased by 0.024 T of Br, increased by 477.6 kA/m of Hcj compared with the pre-diffusion performance of NdFeB magnet. Therefore, the Hcj of diffusion PrDyCu increased more significantly and the advantages were more pronounced.

Example 20, with the same NdFeB magnet composition and size, the same diffusion temperature and aging temperature, etc., the performance of example 20 by diffusion PrDyCu decreased by 0.02 T of Br, increased by 597 kA/m of Hcj compared with the pre-diffusion performance of NdFeB magnet. The performance of comparative example 20 by diffusion Dy decreased by 0.02 T of Br, increased by 477.6 kA/m of Hcj compared with the pre-diffusion performance of NdFeB magnet. Therefore, the Hcj of diffusion PrDyCu increased more significantly and the advantages were more pronounced.

Example 21, with the same NdFeB magnet composition and size, the same diffusion temperature and aging temperature, etc., the performance of example 21 by diffusion PrDyCu decreased by 0.025 T of Br, increased by 756.2 kA/m of Hcj compared with the pre-diffusion performance of NdFeB magnet. The performance of comparative example 21 by diffusion Dy decreased by 0.024 T of Br, increased by 557.2 kA/m of Hcj compared with the pre-diffusion performance of NdFeB magnet. Therefore, the Hcj of diffusion PrDyCu increased more significantly and the advantages were more pronounced.

Example 22, with the same NdFeB magnet composition and size, the same diffusion temperature and aging temperature, etc., the performance of example 22 by diffusion PrDyCu decreased by 0.02 T of Br, increased by 597 kA/m of Hcj compared with the pre-diffusion performance of NdFeB magnet. The performance of comparative example 22 by diffusion Dy decreased by 0.02 T of Br, increased by 398 kA/m of Hcj compared with the pre-diffusion performance of NdFeB magnet. Therefore, the Hcj of diffusion PrDyCu increased more significantly and the advantages were more pronounced.

From the above, it can be seen that after diffusion and aging the coercivity of the examples of Table 3 is significantly better than the coercivity of the comparative examples of Table 4.

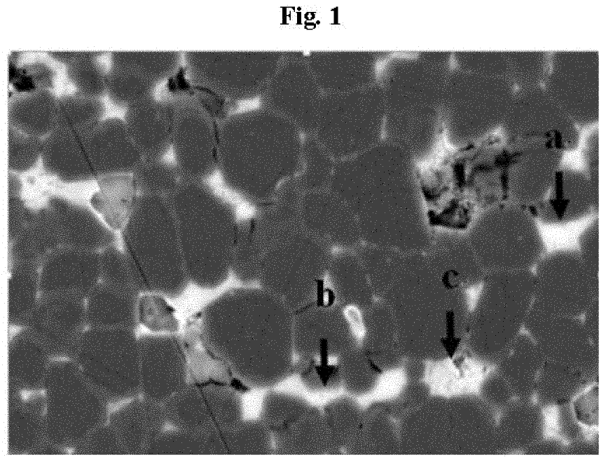

Microstructure assays of the magnets of Table 3 are determined by SEM with a ZISS electron microscopy and EDS of Oxford. The following can be seen: A rare earth shell, that is to say, R shell, is around of more than 60% of the grain, and a transition metal shell is around of more than 40% of the grain. In addition, three sampling points (a), (b), (c) are determined at different locations. However, the small triangle area with a size <1 μm is characterized by a 6:14 phase type rich Cu, that is, the chemical formula of EDS is: Fe₃₀₋₅₁(NdPr)₄₅₋₆₀Cu₂₋₁₅Ga₀₋₅Co₀₋₅ or Fe₃₀₋₅₁(NdPr)₄₅₋₆₀Dy₂₋₁₅Cu₂₋₁₅Ga₀₋₅Co₀₋₅, where the number is the percentage of weight at the foot of the element. The three points are shown in FIG. 1. White phase area of the point composition a, which is sample point composition 1 are summarized as Formula 1. Grey phase area of the point composition b, which is sample point composition 2 are summarized as Formula 3. Sandwich shape area including heavy rare earth element of the point composition c, which is sample point composition 3 are summarized as Formula 2.

### Example 1

The magnet diffused with PrDyCu has the following microstructure: Pr, Dy rare earth shell and transition metal shell Cu, and the formation of sample point composition 1: Nd₅₀₋₇₀Fe₁₀₋₃₀Pr₁₀₋₂₀Cu₀₋₅, sample point composition 2: Nd₅₀₋₇₀Fe₁₀₋₃₅Pr₁₀₋₂₀Cu₁₀₋₂₀Co₀₋₅, sample point composition 3: Nd₅₀₋₅₅Fe₁₀₋₃₀Pr₅₋₁₅Dy₅₋₁₅Cu₀₋₅.

### Example 2

The magnet diffused with PrDyCu has the following microstructure: Pr, Dy rare earth shell and transition metal shell Cu, and the formation of sample point composition 1: Nd₅₀₋₆₅Fe₁₀₋₃₀Pr₁₀₋₂₅Cu₀₋₅Ga₀₋₅Al₀₋₃, sample point composition 2: Nd₅₀₋₇₀Fe₁₀₋₃₅Pr₁₀₋₂₀Cu₁₀₋₁₅Co₀₋₅, sample point composition 3: Nd₅₀₋₅₅Fe₁₀₋₃₀Pr₅₋₁₅Dy₅₋₁₅Cu₀₋₅.

### Example 3

The magnet diffused with PrDyCu has the following microstructure: Pr, Dy rare earth shell and transition metal shell Cu and Al, and the formation of sample point composition 1: Nd₄₅₋₆₀Fe₁₀₋₃₅Pr₁₀₋₂₀Cu₃₋₈Ga₀₋₅Al₃₋₅, sample point composition 2: Nd₄₅₋₆₅Fe₁₀₋₃₀Pr₁₀₋₂₀Cu₁₀₋₂₅Co₀₋₅Al₀₋₅, sample point composition 3: Nd₄₅₋₅₅Fe₁₀₋₃₀Pr₅₋₂₀Dy₅₋₁₀Cu₂₋₅Al₂₋₁₀

### Example 4

The magnet diffused with PrDyCu has the following microstructure: Pr, Dy rare earth shell and transition metal shell Cu and Al, and the formation of sample point composition 1: Nd₄₅₋₆₀Fe₁₀₋₃₅Pr₁₀₋₂₀Cu₃₋₈Ga₀₋₅Al₃₋₅, sample point composition 2: Nd₄₅₋₆₅Fe₁₀₋₃₀Pr₁₀₋₂₀Cu₁₀₋₂₅Co₀₋₅Al₀₋₅, sample point composition 3: Nd₄₅₋₅₅Fe₁₀₋₃₀Pr₅₋₂₀Dy₅₋₁₀Cu₂₋₅Al₂₋₁₀

### Example 5

The magnet diffused with NdDyCu has the following microstructure: Nd, Dy rare earth shell and transition metal shell Cu, and the formation of sample point composition 1: Nd₅₀₋₆₅Pr₁₀₋₁₅Fe₁₀₋₃₀Cu₂₋₆Go₀₋₅, sample point composition 2: Nd₄₅₋₆₀Pr₁₀₋₂₀Fe₅₋₃₀Cn₁₀₋₂₀Co₀₋₅, sample point composition 3: Nd₄₅₋₆₀Pr₅₋₁₅Dy₅₋₁₅Fe₅₋₃₀

### Example 6

The magnet diffused with NdDyCu has the following microstructure: Nd, Dy rare earth shell and transition metal shell Cu, and the formation of sample point composition 1: Nd₄₅₋₆₀Pr₁₀₋₂₀Fe₁₀₋₃₀Cu₂₋₅Ga₀₋₅ sample point composition 2: Nd₅₀₋₆₀Pr₁₀₋₁₅Fe₅₋₂₅Cu₅₋₂₅Co₀₋₅, sample point composition 3: Nd₄₅₋₆₀Pr₅₋₁₂Dy₅₋₂₀Fe₅₋₂₅

### Example 7

The magnet diffused with NdDyCu has the following microstructure: Nd, Dy rare earth shell and transition metal shell Cu and Al, and the formation of sample point composition 1: Nd₅₀₋₆₅Pr₁₀₋₁₅Fe₁₀₋₄₀Cu₅₋₁₀Al₀₋₅ sample point composition 2: Nd₅₀₋₆₀Pr₁₀₋₁₅Fe₅₋₂₅Cu₅₋₁₅Co₀₋₅Al₀₋₅, sample point composition 3: Nd₅₀₋₆₀Pr₅₋₁₅Dy₅₋₂₅Fe₅₋₃₀Al₂₋₁₀

### Example 8

The magnet diffused with PrDyCu has the following microstructure: Pr, Dy rare earth shell and transition metal shell Cu, and the formation of sample point composition 1: Nd₄₀₋₆₀Pr₂₀₋₃₀Fe₁₀₋₃₀Cu₃₋₈ sample point composition 2: Nd₃₅₋₅₀Pr₁₅₋₃₀Fe₅₋₂₅Cu₅₋₂₀Co₀₋₅, sample point composition 3: Nd₃₅₋₄₅Pr₁₀₋₂₅Dy₅₋₂₅Fe₁₀₋₃₀Co₀₋₅Cu₀₋₅

### Example 9

The magnet diffused with PrDyCu has the following microstructure: Pr, Dy rare earth shell and transition metal shell Cu, and the formation of sample point composition 1: Nd₄₀₋₆₀Pr₂₀₋₃₀Fe₁₀₋₃₀Cu₃₋₈ sample point composition 2: Nd₃₅₋₅₀Pr₁₅₋₃₀Fe₅₋₂₅Cu₅₋₂₀Co₀₋₅, sample point composition 3: Nd₃₅₋₄₅Pr₁₅₋₂₅Dy₅₋₂₅Fe₁₀₋₃₀Co₀₋₅Cu₀₋₅

### Example 10

The magnet diffused with PrDyCu has the following microstructure: Pr, Dy rare earth shell and transition metal shell Cu, and the formation of sample point composition 1: Nd₄₀₋₆₀Pr₂₀₋₃₅Fe₁₀₋₃₀Cu₀₋₅ sample point composition 2: Nd₃₅₋₄₅Pr₁₅₋₃₅Fe₅₋₃₀Cu₅₋₂₀Co₀₋₅, sample point composition 3: Nd₂₅₋₄₀Pr₁₀₋₂₅Dy₅₋₁₅Fe₁₀₋₃₀Co₀₋₅Cu₀₋₅

### Example 11

The magnet diffused with PrDyCu has the following microstructure: Pr, Dy rare earth shell and transition metal shell Cu, and the formation of sample point composition 1: Nd₅₀₋₆₅Fe₁₀₋₂₅Pr₁₀₋₂₀Cu₀₋₅Ga₀₋₅Al₀₋₅ sample point composition 2: Nd₄₅₋₇₀Fe₁₀₋₃₀Pr₁₀₋₂₅Cu₁₀₋₂₅Co₀₋₅Ga₀₋₅, sample point composition 3: Nd⁴⁵⁻⁵⁵Fe₁₀₋₃₀Pr₅₋₂₀Dy₅₋₂₀Cu₀₋₅

### Example 12

The magnet diffused with PrDyCu has the following microstructure: Pr, Dy rare earth shell and transition metal shell Cu, and the formation of sample point composition 1: Nd₅₀₋₆₅Fe₁₀₋₃₀Pr₁₀₋₂₅Cu₀₋₅Ga₂₋₇Al₃₋₇ sample point composition 2: Nd₅₀₋₆₅Fe₁₀₋₃₅Pr₅₋₂₀Cu₁₀₋₂₀Cu₀₋₅Al₀₋₅, sample point composition 3: Nd₄₅₋₅₅Fe₁₀₋₃₀Pr₅₋₂₀Dy₅₋₁₀Cu₀₋₅Ga₀₋₅

### Example 13

The magnet diffused with PrDyCuGa has the following microstructure: Pr, Dy rare earth shell and transition metal shell Cu and Ga, and the formation of sample point composition 1: Nd₄₅₋₅₅Pr₂₀₋₂₅Fe₁₅₋₃₀Ga₂₋₁₀Cu₃₋₅ sample point composition 2: Nd₃₅₋₄₅Pr₂₅₋₃₅Fe₁₀₋₃₅Cu₅₋₁₅Ga₅₋₁₀Co₂₋₅, sample point composition 3: Nd₃₀₋₄₅Pr₂₅₋₃₀Dy₅₋₁₅Fe₅₋₂₅Cu₀₋₅

### Example 14

The magnet diffused with PrDyCuGa has the following microstructure: Pr, Dy rare earth shell and transition metal shell Cu and Ga, and the formation of sample point composition 1: Nd₄₀₋₅₅Pr₂₀₋₃₀Fe₁₅₋₃₀Ga₂₋₁₀Cu₃₋₅ sample point composition 2: Nd₃₀₋₅₀Pr₂₅₋₃₀Fe₁₀₋₃₀Cu₅₋₁₀Ga₅₋₁₀Co₂₋₅, sample point composition 3: Nd₃₀₋₄₀Pr₂₅₋₃₀Dy₅₋₁₅Fe₅₋₂₅Cu₀₋₅

### Example 15

The magnet diffused with PrDyCuGa has the following microstructure: Pr, Dy rare earth shell and transition metal shell Cu and Ga, and the formation of sample point composition 1: Nd₄₀₋₅₅Pr₂₀₋₃₀Fe₁₅₋₂₅Ga₅₋₁₀Cu₃₋₁₀ sample point composition 2: Nd₃₀₋₄₅Pr₂₅₋₃₅Fe₁₀₋₃₀Cu₅₋₁₀Ga₅₋₁₀Co₂₋₅, sample point composition 3: Nd₃₀₋₄₀Pr₁₅₋₃₀Dy₅₋₂₀Fe₅₋₂₅Cu₀₋₅

### Example 16

The magnet diffused with PrDyCuAl has the following microstructure: Pr, Dy rare earth shell and transition metal shell Cu and Al, and the formation of sample point composition 1: Nd₄₅₋₆₅Fe₁₀₋₃₅Pr₅₋₁₅Cu₅₋₁₅Al₅₋₁₀ sample point composition 2: Nd₅₀₋₆₅Fe₁₀₋₂₀Pr₁₀₋₁₅Cu₁₀₋₂₅Al₀₋₅, sample point composition 3: Nd₄₅₋₆₅Fe₅₋₃₀Pr₅₋₂₀Dy₅₋₁₀Cu₅₋₁₀Al₂₋₁₀

### Example 17

The magnet diffused with PrDyCuAl has the following microstructure: Pr, Dy rare earth shell and transition metal shell Cu and Al, and the formation of sample point composition 1: Nd₄₅₋₅₅Fe₁₀₋₃₀Pr₅₋₂₀Cu₅₋₁₀Al₂₋₅ sample point composition 2: Nd₄₅₋₆₀Fe₁₀₋₂₀Pr₁₀₋₂₀Cu₁₀₋₂₀Ga₀₋₅Al₀₋₅, sample point composition 3: Nd₄₅₋₆₀Fe₅₋₂₅Pr₅₋₂₅Dy₅₋₁₅Cu₅₋₁₀Al₃₋₅

### Example 18

The magnet diffused with PrDyCuAl has the following microstructure: Pr, Dy rare earth shell and transition metal shell Cu and Al, and the formation of sample point composition 1: Nd₅₀₋₆₅Fe₁₀₋₃₀Pr₅₋₂₀Cu₅₋₁₀Al₂₋₅ sample point composition 2: Nd₄₅₋₆₀Fe₁₀₋₂₅Pr₁₀₋₂₀Cu₁₀₋₂₀Ga₀₋₅Al₀₋₅, sample point composition 3: Nd₄₅₋₆₅Fe₅₋₃₀Pr₅₋₂₀Dy₅₋₁₅Cu₅₋₁₀Al₅₋₁₀

### Example 19

The magnet diffused with PrDyCu has the following microstructure: Pr, Dy rare earth shell and transition metal shell Cu, and the formation of sample point composition 1: Nd₄₅₋₅₅Fe₅₋₃₀Pr₂₀₋₃₅Cu₀₋₅ sample point composition 2: Nd₃₅₋₅₅Fe₅₋₃₀Pr₁₀₋₃₅Cu₅₋₁₀Ga₀₋₅Co₀₋₅ sample point composition 3: Nd₄₅₋₅₅Fe₅₋₁₀Pr₁₀₋₃₀Dy₅₋₂₀Cu₀₋₅

### Example 20

The magnet diffused with PrDyCu has the following microstructure: Pr, Dy rare earth shell and transition metal shell Cu, and the formation of sample point composition 1: Nd₃₅₋₅₀Fe₁₅₋₄₀Pr₁₅₋₃₀Cu₀₋₁₀Ga₀₋₃Al₀₋₃ sample point composition 2: Nd₄₀₋₅₅Fe₅₋₃₅Pr₁₅₋₃₀Cu₅₋₂₅Ga₀₋₅Co₀₋₅ sample point composition 3: Nd₄₀₋₆₀Fe₃₋₃₀Pr₁₀₋₂₀Dy₅₋₂₅

### Example 21

The magnet diffused with PrDyCu has the following microstructure: Pr, Dy rare earth shell and transition metal shell Cu, and the formation of sample point composition 1: Nd₃₀₋₄₅Fe₁₀₋₃₀Pr₂₀₋₂₅Cu₅₋₁₀Ga₀₋₅Co₀₋₅Ti₀₋₅ sample point composition 2: Nd₃₅₋₄₅Fe₅₋₃₀Pr₁₅₋₃₀Cu₅₋₂₅Ga₀₋₃Co₀₋₅ sample point composition 3: Nd₃₀₋₄₀Fe₅₋₂₅Pr₁₀₋₁₅Dy₁₀₋₃₀Ho₅₋₁₀

### Example 22

The magnet diffused with PrDyCu has the following microstructure: Pr, Dy rare earth shell and transition metal shell Cu, and the formation of sample point composition 1: Nd₂₅₋₃₅Fe₂₀₋₃₀Pr₂₀₋₃₀Cu₀₋₁₀Ga₀₋₅ sample point composition 2: Nd₄₀₋₅₅Fe₁₀₋₂₅Pr₁₅₋₄₀Cu₅₋₂₀Ga₀₋₁₀Co₀₋₅, sample point composition 3: Nd₄₅₋₅₅Fe₁₀₋₂₀Pr₂₀₋₃₀Dy₅₋₂₀

What claimed is:

1. A method of preparing a low-heavy rare earth magnet comprising the following steps:
S1, smelting and strip casting of the raw materials of a NdFeB alloy to obtain a NdFeB alloy sheets, and mechanically crushing the NdFeB alloy sheets into flaky alloy sheets, wherein the NdFeB alloy has the following composition in weight percentage:28%≤R≤30%, 0.8%≤B≤1.2%, 0≤Gd≤5%, 0≤Ho≤5%, and 0≤M≤3%,
wherein R is at least two or more elements of Nd, Pr, Ce, La, Tb, and Dy, M is at least one element of Co, Mg, Ti, Zr, Nb, and Mo, and the rest of the NdFeB alloy is Fe;
S2, mechanically mixing the flaky alloy sheets, a low melting point powder and a lubricant to obtain a mixture, followed by hydrogen absorption and dehydrogenation treatment of the mixture and jet milling of the product to obtain a NdFeB magnet powder, wherein the low melting point powder contains at least one component selected from NdCu, NdAl and NdGa, and a weight percentage of the NdCu is 0% to 3%, a weight percentage of the NdAl is 0% to 3%, a weight percentage of the NdGa is 0% to 3%, each with respect to the total weight of the flaky alloy sheets and the low melting point powder;
S3, pressing, forming and sintering the NdFeB magnet powder to obtain a sintered NdFeB magnet;
S4, mechanically processing the sintered NdFeB magnet to a desired shape, and then forming a diffusion source film on the surface of the sintered NdFeB magnet, wherein the diffusion source film including a diffusion source of formula RxHyM1-x-y,
wherein R is at least one of Nd, Pr, Ce, La, Ho, and Gd, H is at least one of Tb and Dy, M is at least one of Al, Cu, Ga, Ti, Co, Mg, Zn, and Sn, x and y are set to be 10%≤x≤50% and 40%≤y≤70% in weight percentage; and
S5, performing a diffusion process and aging to obtain the low-heavy rare earth magnet.

2. The method of preparing a low-heavy rare earth magnet of claim 1, wherein in the step S2 a weight content of Cu is 0.1% to 0.5%, a weight content of Al is 0.2% to 0.9%, and a weight content of Ga is 0.01% to 0.4%, each with respect to the total weight of the flaky alloy sheets and the low melting point powder.

3. The method of preparing a low-heavy rare earth magnet of claim 1, wherein in the NdFeB alloy of the step S1, R is at least one element of Nd and Pr, and M is at least one element of Co and Ti.

4. The method of preparing a low-heavy rare earth magnet of claim 2, wherein in the NdFeB alloy of the step S1, R is at least one element of Nd and Pr, and M is at least one element of Co and Ti.

5. The method of preparing a low-heavy rare earth magnet of claim 1, wherein in the diffusion source film of the step S4, R is at least one of Nd and Pr, H is Dy, and M is at least one of Al, Cu, and Ga.

6. The method of preparing a low-heavy rare earth magnet of claim 1, wherein in the step S2, the dehydrogenation temperature is 400 to 600° C.

7. The method of preparing a low-heavy rare earth magnet of claim 1, wherein in the step S2, an average particle size D50 of the low melting point powder is 200 nm to 4 μm measured by laser diffraction (LD).

8. The method of preparing a low-heavy rare earth magnet of claim 1, wherein in the step S2, an average particle size D50 of the NdFeB magnet powder is 3 to 5 μm after jet milling measured by laser diffraction (LD).

9. The method of preparing a low-heavy rare earth magnet of claim 1, wherein in the step S3, the sintering temperature of the NdFeB magnet is 980 to 1060° C. and the sintering time is 6 to 15 h.

10. The method of preparing a low-heavy rare earth magnet of claim 1, wherein in the step S5, the diffusion temperature of NdFeB magnets is 850 to 930° C. and the diffusion time is 6 to 30 h.

11. The method of preparing a low-heavy rare earth magnet of claim 1, wherein in the step S5, an aging temperature is 420 to 680° C., an aging time is 3 to 10 h, an aging heating rate is 1 to 5° C./min, and an aging cooling rate is 5 to 20° C./min.

12. A sintered NdFeB magnet produced by the method of preparing a low-heavy rare earth magnet of claim 1.

13. The sintered NdFeB magnet of claim 12, wherein a phase structure of the sintered NdFeB magnet comprising:
a main phase;
an R shell consisting of at least one of Nd, Pr, Ce, La, Ho, and Gd and partially covering the main phase;
a transition metal shell consisting of at least one of Cu, Al, and Ga and partially covering the main phase; and
a triangular region consisting of at least one composition of Formulas 1 to 3:
Formula 1, NdaFebRcMd, wherein R is at least one element of Pr, Ce, La, Ho, and Gd;
M is at least three elements of Al, Cu, Ga, Ti, Co, Mg, Zn, and Sn; and a, b, c, and d are set to be 30%≤a≤70%, 5%≤b≤40%, 5%≤c≤35%, and 0%≤d≤15% in weight percentage;
Formula 2, NdeFefRgHhKiMj, wherein R is at least one element of Pr, Ce, La; H is at least one element of Dy and Tb; M is at least three elements of Al, Cu, Ga, Ti, Co, Mg, Zn, and Sn; e, f, g, h, I, and j are set to be 25%≤e≤65%, 5%≤f≤35%, 5%≤g≤30%, 5%≤h≤30%, 5%≤i≤10%, and 0%≤j≤10% in weight percentage;
Formula 3, NdkFelRmDnMo, wherein R is at least one element of Pr, Ce, La, Ho, and Gd; D is at least one element of Al, Cu, and Ga; M is at least one element of Ti, Co, Mg, Zn, and Sn; k, l, m, n, and o are set to be 30%≤k≤70%, 5%≤l≤35%, 5%≤m≤35%, 5%≤n≤25%, and 0%≤o≤10% in weight percentage.

14. The sintered NdFeB magnet of claim 12, wherein a thickness of the sintered NdFeB magnet is 0.3 to 6 mm.
